(19) United States
(12) Patent Application Publication
(10) Pub. No.: US 2018/0231037 A1
(43) Pub. Date: Aug. 16, 2018

(54) FLOATING FASTENER

(71) Applicant: HANWIT PRECISION INDUSTRIES LTD., New Taipei (TW)

(72) Inventors: Ming-De WU, New Taipei (TW); Chih-Yuan CHEN, New Taipei (TW)

(21) Appl. No.: 15/861,174

(22) Filed: Jan. 3, 2018

(30) Foreign Application Priority Data
Feb. 10, 2017 (TW) 106202006

(51) Int. Cl. F16B 5/02

(52) U.S. Cl. CPC F16B 5/0208; F16B 37/044

(57) ABSTRACT

A floating fastener includes a socket defining therein a socket hole, an electrically insulative barrel having a barrel hole that accommodates the socket and a bottom through hole axially disposed in communication with the socket hole, a locking device having a head disposed above the socket, a shoulder located at the bottom wall of the head and insertable into the socket hole of the socket and a shank extended from the shoulder and insertable through the socket hole of the socket, and an electrically insulative operating cap affixed to the head of the locking device and defining therein an internal chamber that receives the socket, the insulating barrel and the locking device. Subject to the protection of the electrically insulative barrel and the electrically insulative operating cap, the floating fastener will not conduct electrical contacts if it accidentally falls to a circuit board, enhancing safety.

This application claims the priority benefit of Taiwan patent application number 106202006, filed on Feb. 10, 2017.

### BACKGROUND OF THE INVENTION

### 1. Field of the Invention

The present invention relates to fasteners for detachably fastening plate members in a stack and more particularly, to a floating fastener, which comprises a metal socket, an insulating barrel mounted around the metal socket, a locking device axially movably mounted in the metal socket and loaded with an elastic member, and an operating cap made of an insulative material and affixed to the head of the locking device. Subject to the electrically insulative material property of the barrel and the operating cap, the floating fastener has a complete insulation protection effect.

### 2. Description of the Related Art

When joining metal panel members, fastening devices respectively formed of a lock screw, a rotary knob and a washer may be used. During application, the lock screw, rotary knob and washer of each fastening device are assembled and then mounted at a first metal panel member. When fastening the first metal panel member to a second metal panel member, rotate the rotary knob of each fastening device to drive the respective lock screw into a respective mounting screw hole at the second metal panel member, and then use a hand tool to fasten tight the lock screw. This multiple metal panel member fastening method can be used in a machine tool or other situations where multiple metal panel members are to be fastened in a stack. In a machine tool, the location where metal panel members are fastened together may be at the power drive or speed-adjustment unit inside the housing. The lock screws of the fastening devices may fall from the metal panel members and missed easily due to user's negligence during a metal panel member dismounting procedure for the performance of a repair or speed adjustment operation, affecting further re-installation operation.

With the continuous innovation and progress of computer technology, the application of computer and all kinds of electronic and electrical products has been continuously widened, and the functions of computer and all kinds of electronic and electrical products have also been continuously expanded. In consequence, the circuit layouts, central processing units, chips and various other electronic components for handling operation, computation, analysis and other functions must also be appropriately expanded. However, since the internal space of a computer or other electronic or electrical product is limited, it is difficult to increase the installation surface area in a computer or other electronic or electrical product for the mounting of multiple circuit boards, central processing units, chips and various other electronic components. In order to solve the problem of limited circuit board mounting space in a computer or other electronic or electrical product, board-to-board stacking assembly technology has been created.

FIGS. 8 AND 9 illustrate a conventional floating fastener for detachably fasten a first plate member to a second plate member. As illustrated, the floating fastener comprises a socket A, a locking device B, a compression spring B11, and an operating cap C. The socket A is made of metal, comprising a stepped socket hole A1 cut through opposing top and bottom sides thereof, an inner step A11 defined in the socket hole A1, and an annular stop flange A2 extended around the periphery of the top side thereof. The locking device B is a lock screw, comprising a head B2 disposed above the socket A and a threaded shank B1 downwardly extended from the bottom wall of the head B2 and inserted through the socket hole A1 of the socket A. The compression spring B11 is mounted around the threaded shank B1 and stopped between the bottom wall of the head B2 and the inner step A11 of the socket hole A1. The operating cap C is fixedly fastened to the head B2 of the locking device B, comprising an internal chamber C0 for receiving the locking device B, the compression spring B11 and the socket A, an annular stop flange C1 defined in a bottom side of the internal chamber 1 and stoppable at the bottom side of the annular stop flange A2 of the socket A to prohibit the operating cap C from falling out of the socket A.

In application, the floating fastener can be fastened to a plate member (for example, circuit board). In installation, force down the operating cap C to move the threaded shank B1 of the locking device B out of the socket hole A1 of the socket A, and then operate the operating cap C to rotate the locking device B, threading the threaded shank B1 of the locking device B into a mounting screw hole of the plate member. However, when mounting the floating fastener in a plate member inside a machine housing or dismounting the floating fastener from the plate member, the floating fastener can fall from the user's hand accidentally in the limited internal space of the machine housing. If the floating fastener fall to a circuit board inside the machine housing, the metal socket A can conduct electric contacts of the circuit board, causing short circuit and circuit board burning accidents.

Therefore, it is desirable to provide a floating fastener that eliminates the aforesaid problems.

### SUMMARY OF THE INVENTION

The present invention has been accomplished under the circumstances in view. It is therefore the main object of the present invention to provide an floating fastener, which enhances safety and prevents from accidentally conducting contacts to cause a short circuit accident. It is another object of the present invention to provide an floating fastener, which saves much design and molding costs, facilitating quick installation.

To achieve these and other objects of the present invention, a floating fastener comprises a socket defining therein a socket hole, an electrically insulative barrel having a barrel hole that accommodates the socket and a bottom through hole axially disposed in communication with the socket hole, a locking device having a head disposed above the socket, a shoulder located at the bottom wall of the head and insertable into the socket hole of the socket and a shank extended from the shoulder and insertable through the socket hole of the socket, and an electrically insulative operating cap affixed to the head of the locking device and defining therein an internal chamber that receives the socket, the insulating barrel and the locking device. Subject to the protection of the electrically insulative barrel and the electrically insulative operating cap, the floating fastener will not conduct electrical contacts if it accidentally falls to a circuit board, enhancing safety.

Further, the diameter of the barrel hole of the insulating barrel is slightly smaller than the outer diameter of the socket so that the socket can be tightly press-fitted into the barrel hole of the insulating barrel, facilitating quick positioning between the socket and the insulating barrel without any additional positioning means, saving much installation time and labor and effectively preventing the socket from falling out of the barrel hole.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a floating fastener in accordance with a first embodiment of the present invention.

FIG. 2 is an exploded view of the floating fastener in accordance with the first embodiment of the present invention.

FIG. 3 corresponds to FIG. 2 when viewed from another angle.

FIG. 4 is a sectional side view of the floating fastener in accordance with the first embodiment of the present invention.

FIG. 5 is an exploded view of a floating fastener in accordance with a second embodiment of the present invention.

FIG. 6 is an exploded view of a floating fastener in accordance with a third embodiment of the present invention.

FIG. 7 is an exploded view of a floating fastener in accordance with a fourth embodiment of the present invention.

FIG. 8 is an exploded view of a floating fastener according to the prior art.

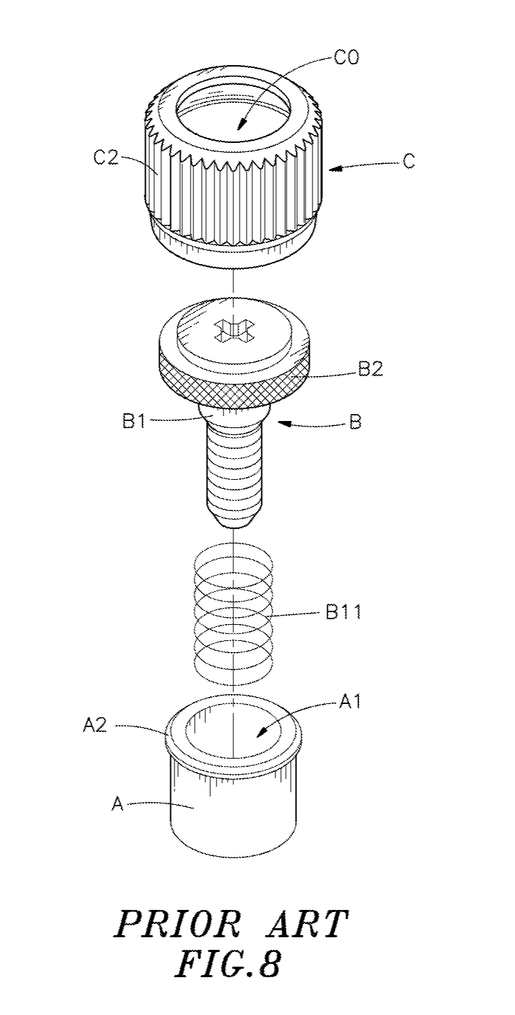

FIG. 9 is a sectional side view of the prior art floating fastener.

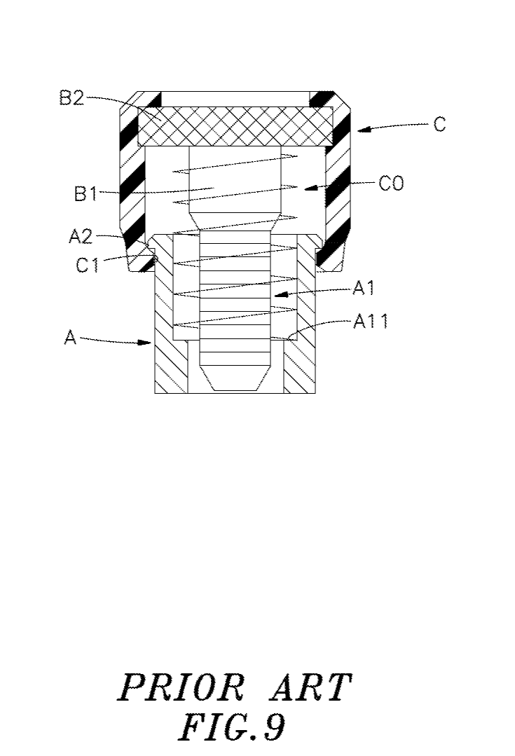

### DETAILED DESCRIPTION OF THE PREFERRED EMBODIMENT

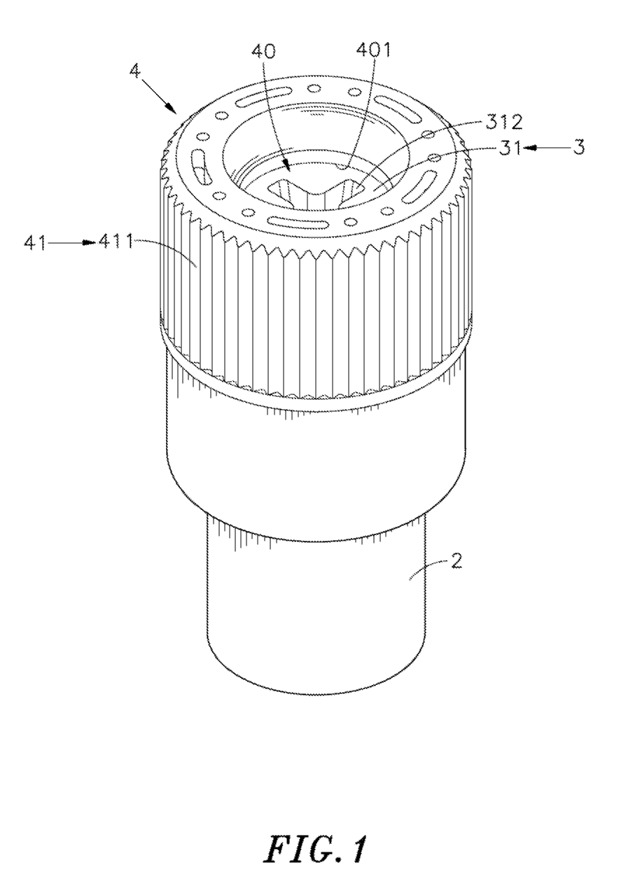

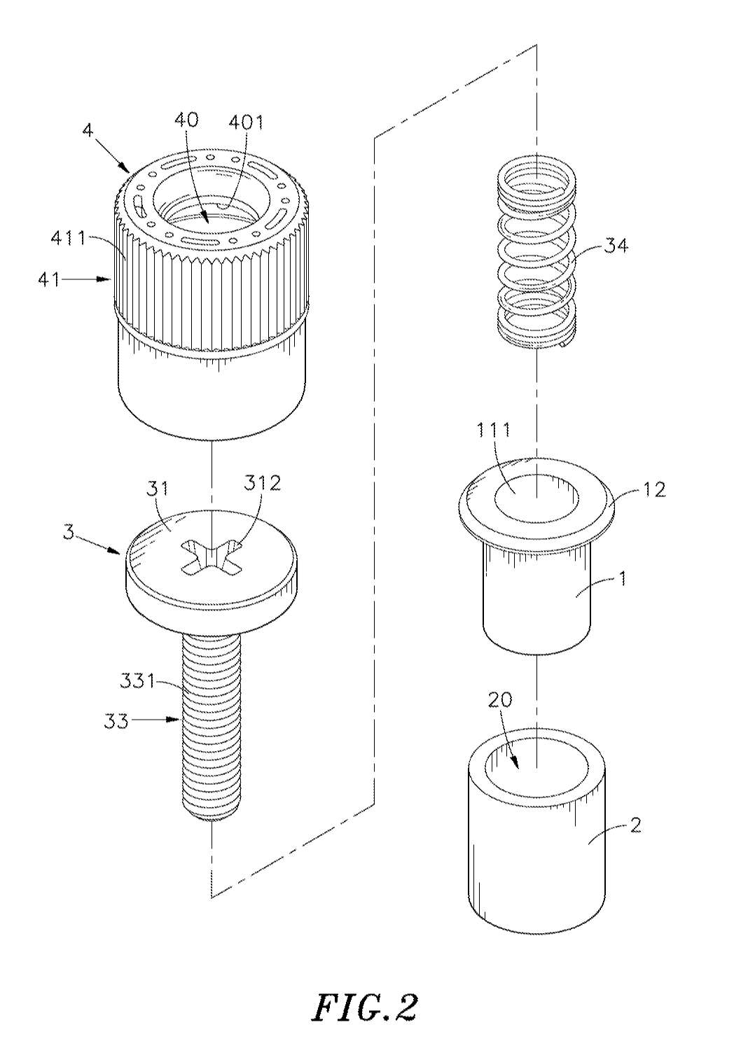

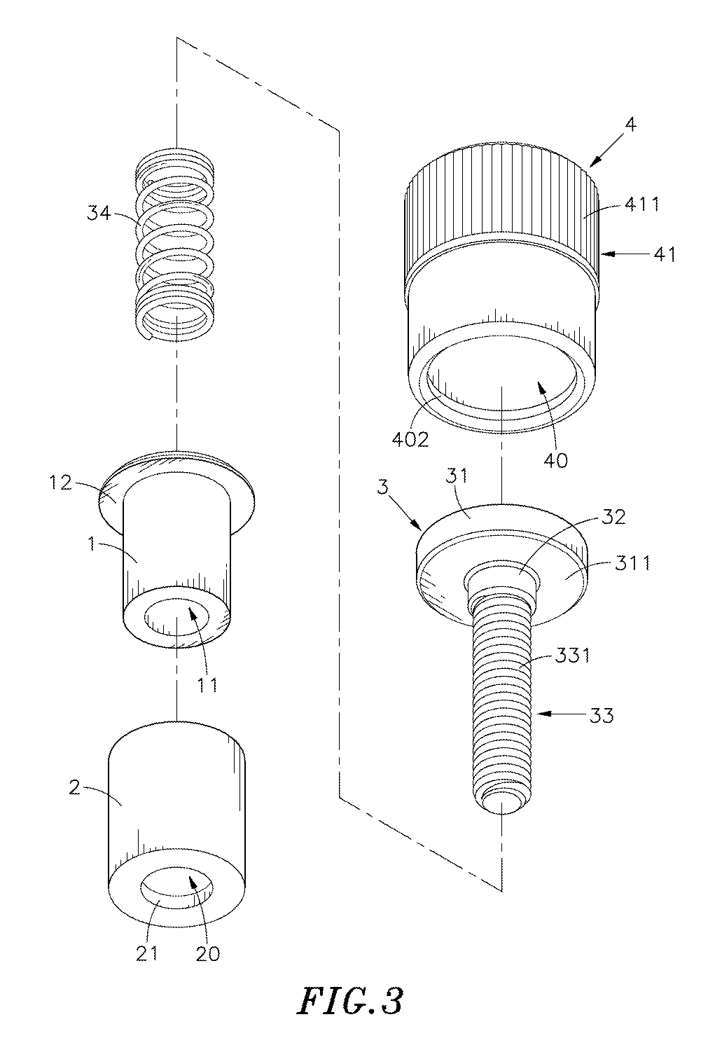

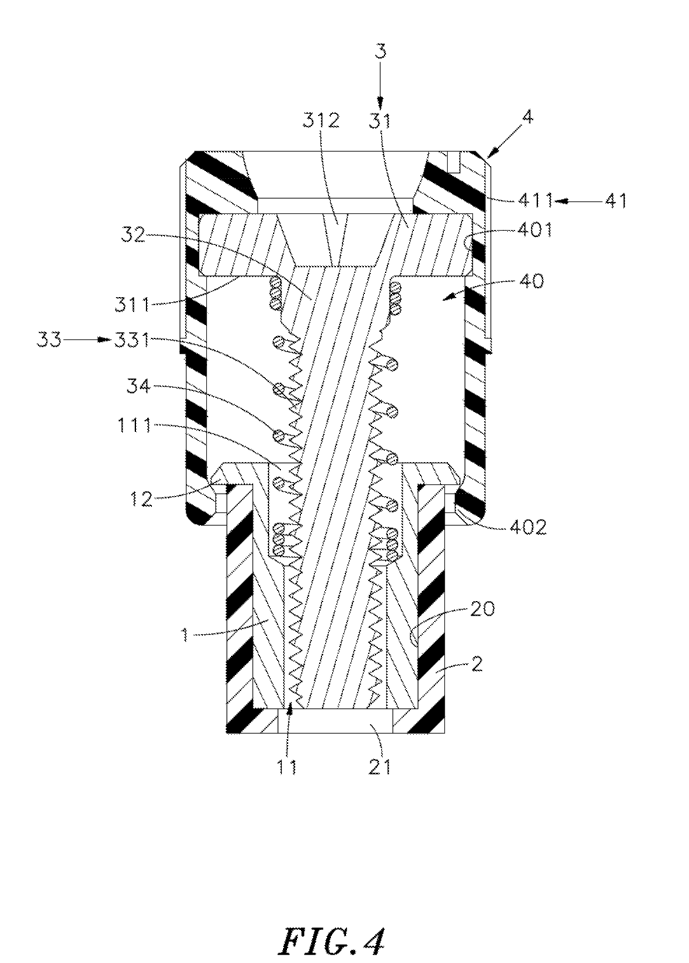

Referring to FIGS. 1-4, a floating fastener in accordance with a first embodiment of the present invention is shown. The floating fastener comprises a socket 1, an insulating barrel 2, a locking device 3, an elastic member 34 and an operating cap 4.

The socket 1 is made of metal, comprising an accommodation open chamber 111 defined in a top side thereof, a socket hole 11 axially downwardly extended from the accommodation open chamber 111 and cut through an opposing bottom side thereof and an annular top flange 12 extended around the periphery of the top side thereof.

The insulating barrel 2 is made from a flexible insulative plastic or rubber material, comprising a barrel hole 20 that receives the socket 1. A bottom through hole 21 located in a bottom side of the insulating barrel 2 thereof in axial alignment with the barrel hole 20 and the socket hole 11 of the socket 1.

The locking device 3 is a lock screw, comprising a head 31 made in, for example, a circular shape and disposed above the socket 1, a shoulder 32 located at the center of a bottom wall 311 of the head 31 and insertable into the accommodation open chamber 111 of the socket 1, a shank 33 axially downwardly extended from the shoulder 32 opposite to the head 31, and an outer thread 331 spirally extended around the periphery of the shank 33. Further, the head 31 of the locking device 3 comprises a driving tool receiving portion 312 located at a top side thereof. The driving tool receiving portion 312 can be a Phillips groove, hex groove, six-point star pattern groove or hex stem, or any other design for receiving a screwdriver or the like that is operable to rotate the locking device 3.

The elastic member 34 can be, for example, an axially compressible coil spring sleeved onto the shank 33 of the locking device 3 with one end thereof fastened to the shoulder 32 and an opposite end thereof positioned in the accommodation open chamber 111 of the socket 1.

The operating cap 4 is made from an insulative plastic or rubber material, comprising an internal chamber 40 cut through opposing top and bottom sides thereof for receiving the socket 1, the insulating barrel 2 and the locking device 3, a mounting groove 401 defined in a top side of the internal chamber 40 for the mounting of the head 31 of the locking device 3, an annular stop flange 402 defined in an opposing bottom side of the internal chamber 40, and a grip 41 with anti-slip ribs 411 located at the periphery.

Preferably, the diameter of the barrel hole 20 of insulating barrel 2 is slightly smaller than the outer diameter of the socket 1 so that the socket 1 can be tightly press-fitted into the barrel hole 20 of the insulating barrel 2. In actual application, the diameter of the barrel hole 20 of insulating barrel 2 can be configured equal to or slightly larger than the outer diameter of the socket 1, allowing the socket 1 to be firmly positioned in the barrel hole 20 of the insulating barrel 2 without vibration or displacement.

Further, the operating cap 4 can be directly molded on the head 31 of the locking device 3. Alternatively, the operating cap 4 can be affixed to the head 31 of the locking device 3 using any of a variety of known mounting techniques.

In installation, put the socket 1 in the barrel hole 20 of the insulating barrel 2 to keep the bottom through hole 21 of the insulating barrel 2 in axial alignment with the socket hole 11 of the socket 1 with the annular top flange 12 of the socket 1 stopped at a top side of the insulating barrel 2 outside the barrel hole 20, and then attach one end of the elastic member 34 onto the shoulder 32 of the locking device 3 to abut against the bottom wall 311 of the head 31, and then insert the locking device 3 downwardly into the socket hole 11 of the socket 1 to let the other end of the elastic member 34 be positioned in the accommodation open chamber 111, and then force the operating cap 4 downwardly to connect to outer surfaces of the socket 1 and the insulating barrel 2 to force the annular stop flange 402 of the operating cap 4 elastically deformably over the annular top flange 12 of the socket 1 and to let the socket 1 and the insulating barrel 2 be received in the internal chamber 40 of the operating cap 4. At this time, the elastic member 34 is elastically deformably stopped against the bottom wall 311 of the head 31, and the annular stop flange 402 of the operating cap 4 is stopped at a bottom wall of the annular top flange 12 of the socket 1 to prohibit the locking device 3 from falling out of the socket 1, and thus, the socket 1, the insulating barrel 2, the locking device 3 and the operating cap 4 are coupled together.

The socket 1 and the locking device 3 are respectively made of metal; the operating cap 4 can be molded on the head 31 of the locking device 3 using insert molding technology, or the mounting groove 401 the operating cap 4 can be affixed to the head 31 using a mounting technique; the annular stop flange 402 of the operating cap 4 is stopped at the bottom wall of the annular top flange 12 of the socket 1 to prohibit the locking device 3 from falling out of the socket 1. However, the stopping structure between the operating cap 4 and the socket 1 can be variously embodied, for example, C-shaped retainer, cushion ring or any other stopper means (not shown) can be selectively used and fastened to the socket 1 for stopping against a flanged part of the shank 33 of the locking device 3 to prohibit the locking device 3 from falling out of the socket 1.

The floating fastener can be used in a circuit board inside a machine housing, a telecommunication cabinet, computer server, working machine, drawer, keyboard rack, etc. to detachably fasten board or plate members together. In application, stop the insulating barrel 2 against an external plate member (not shown) to keep the bottom through hole 21 of the insulating barrel 2 in axial alignment with the mounting screw hole (not shown) of the external plate member, and then push the operating cap 4 toward the external plate member to force the head 31 of the locking device 3 against the elastic member 34 and to further move the shank 33 of the locking device 3 out of the socket hole 11 of the socket 1 and the bottom through hole 21 of the insulating barrel 2, and then operate the grip 41 of the operating cap 4 with the hand or a hand tool (open-end wrench or socket wrench) to rotate the operating cap 4 and the locking device 3, or, attach a power hand tool (electrical screwdriver) or a hand tool (screwdriver or wrench) to the driving tool receiving portion 312 of the head 31 to rotate the locking device 3, driving the outer thread 331 of the shank 33 into the mounting screw hole of the external plate member, and thus, the floating fastener is fastened to the external plate member.

When wishing to dismount the floating fastener from the mounting screw hole of the external plate member, grasp the anti-slip ribs 411 of the grip 41 of the operating cap 4 to rotate the operating cap 4 and the head 31 of the locking device 3 in the reversed direction, disconnecting the outer thread 331 of the shank 33 of the locking device 3 from the mounting screw hole of the external plate member. Alternatively, the user can attach a hand tool (screwdriver or wrench) to the driving tool receiving portion 312 of the head 31 of the locking device 3, and then operate the hand tool to rotate the head 31 of the locking device 3, disconnecting the outer thread 331 of the shank 33 of the locking device 3 from the mounting screw hole of the external plate member for replacement of the external plate member or the performance of a maintenance work.

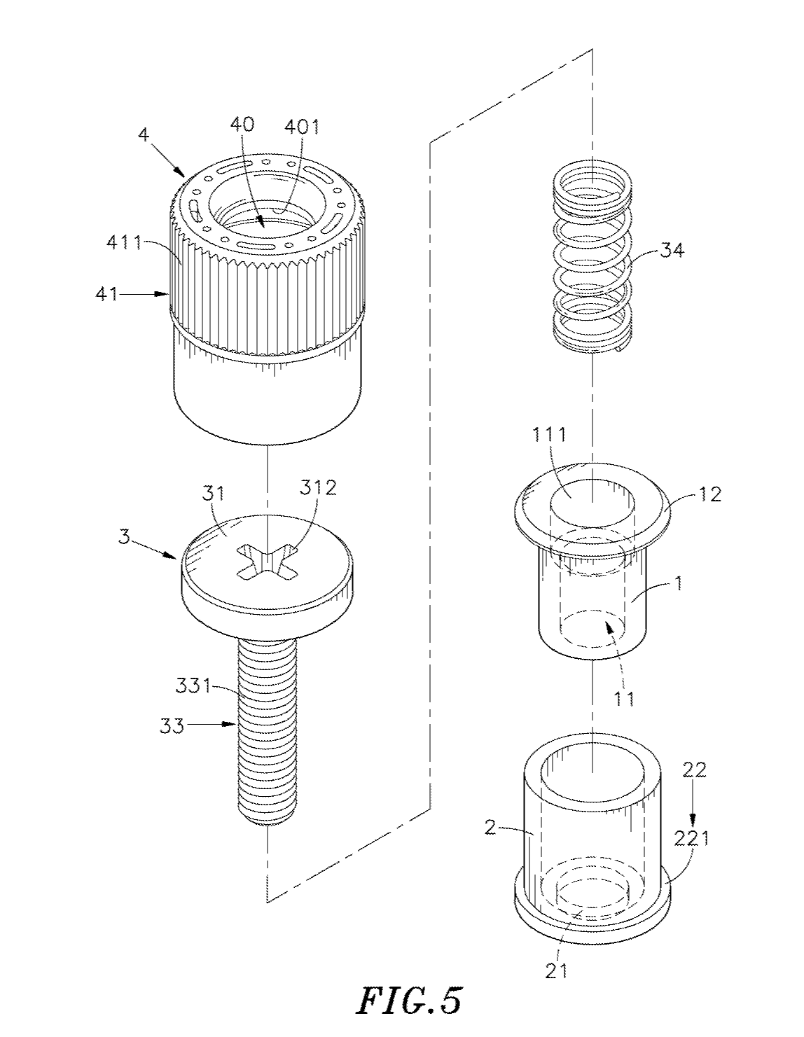

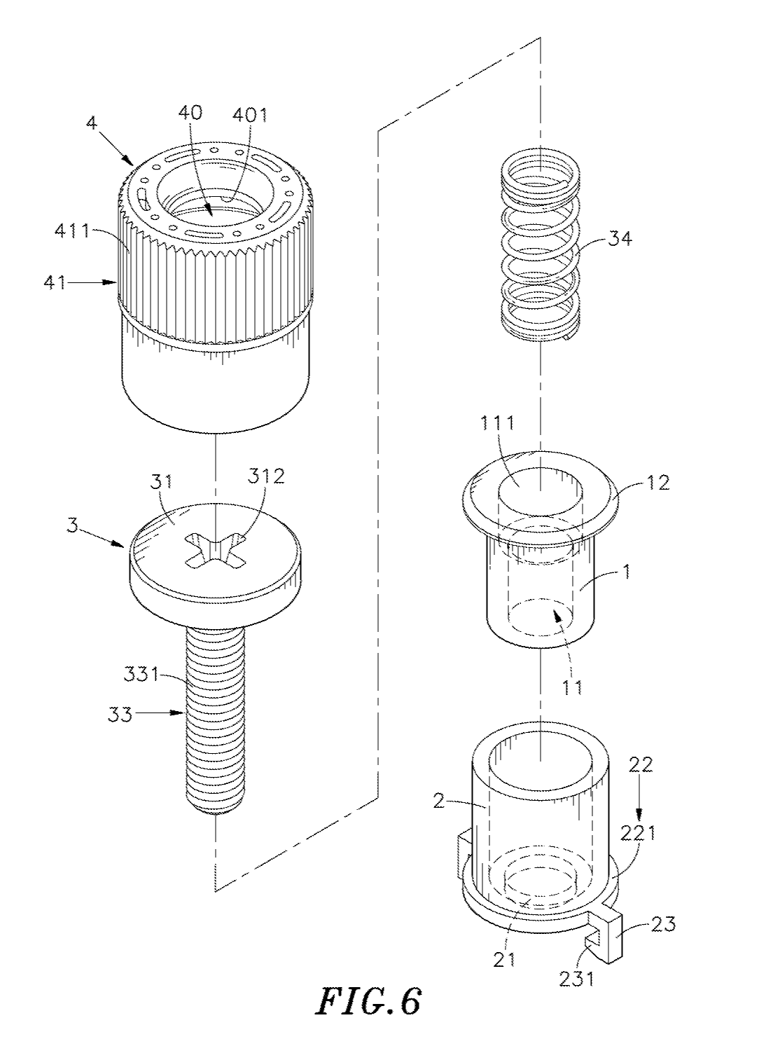

FIG. 5 illustrates a floating fastener in accordance with a second embodiment of the present invention. FIG. 6 illustrates a floating fastener in accordance with a third embodiment of the present invention. The floating fastener in accordance with the second and third embodiments of the present invention are substantially similar to the aforesaid first embodiment with the exception that the insulating barrels 2 of the second and third embodiment further comprise an abutment structure 22 extended around the bottom through hole 21. In the second embodiment, as shown in FIG. 5, the abutment structure 22 comprises an annular abutment flange 221 extended around the bottom through hole 21 and disposed in flush with the bottom wall of the barrel 2 for abutment against the external plate member around the mounting screw hole of the external plate member to enhance installation stability against vibration. In the third embodiment, as shown in FIG. 6, the abutment structure 22 further comprises a plurality of connection members 23 respectively extended from the annular abutment flange 221 and respectively terminating in an inwardly curved hook block 231 for hooking in a respective locating hole (not shown) in an external plate member.

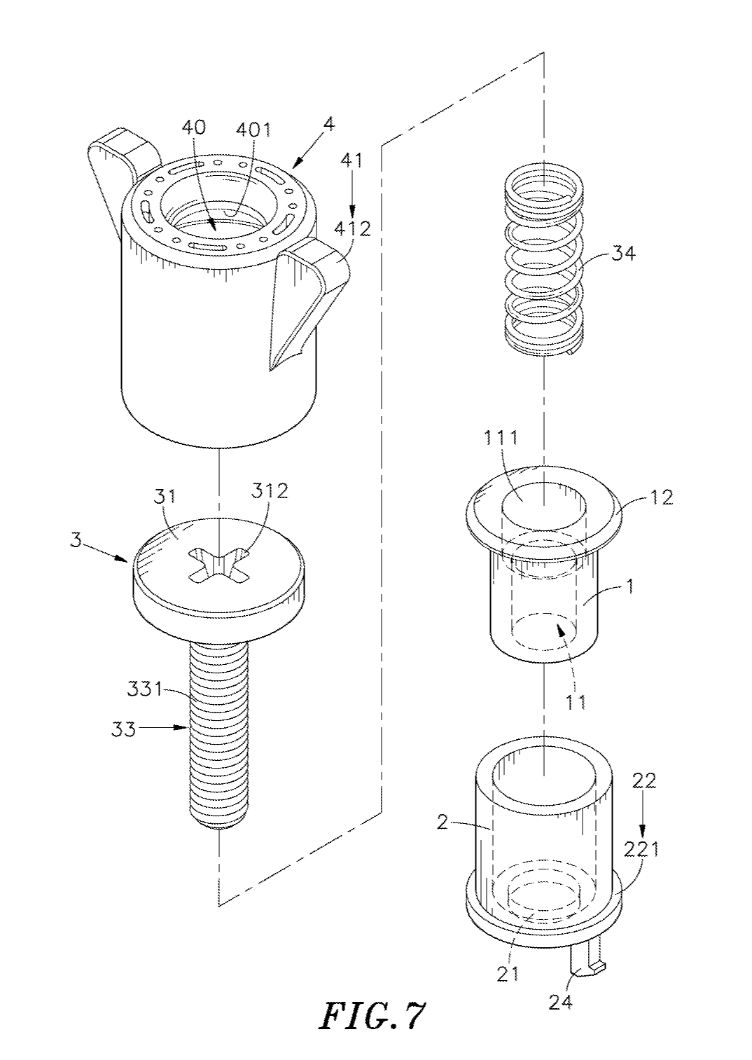

FIG. 7 illustrates a floating fastener in accordance with a fourth embodiment of the present invention. This fourth embodiment is substantially similar to the aforesaid second embodiment with the exception that the abutment structure 22 of the barrel 2 of this fourth embodiment further comprises a plurality of hooks 24 respectively downwardly extended from the annular abutment flange 221 for hooking in respective hook holes in an external plate member (not shown); the grip 41 of the operating cap 4 of this fourth embodiment eliminates the aforesaid anti-slip ribs 411 and provides a plurality of finger block 412 that are spaced around the periphery of the of the operating cap 4 for being driven by the user's fingers to rotate the operating cap 4 and the locking device 1 relative to the socket 1 and the barrel 2.

In general, the invention achieves the effects as follows:
1. The socket 1 is mounted in the barrel hole 20 of the barrel 2 and the operating cap 4 is affixed to the locking device 3, thus, the socket 1 and the locking device 3 are surrounded by the electrically insulative barrel 2 and the electrically insulative operating cap 4; in case the floating fastener accidentally falls to a circuit board, the electrically insulative barrel 2 and the electrically insulative operating cap 4 provide a protection to prevent from the fallen floating fastener from accidentally conducting multiple contacts in the circuit board to cause a short circuit accident, enhancing safety.
2. The diameter of the barrel hole 20 of the insulating barrel 2 is slightly smaller than the outer diameter of the socket 1 so that the socket 1 can be tightly press-fitted into the barrel hole 20 of the insulating barrel 2, facilitating quick positioning between the socket 1 and the insulating barrel 2 without any additional positioning means, saving much installation time and labor and effectively preventing the socket 1 from falling out of the barrel hole 20.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A floating fastener, comprising a socket, an insulating barrel, a locking device and an operating cap, wherein:
said socket comprises a socket hole cut through opposing top and bottom sides thereof;
said insulating barrel is made from an insulative material, comprising a barrel hole that accommodates said socket and a bottom through hole cut through a bottom wall of said barrel hole thereof and axially disposed in communication with said socket hole;
said locking device comprises a head disposed above said socket and defining a bottom wall, a shoulder located at said bottom wall of said head and insertable into said socket hole of said socket, and a shank extended from said shoulder opposite to said head and insertable through said socket hole of said socket and said bottom through hole of said insulating barrel;
said operating cap is made of an insulating material and fixedly mounted to said head of said locking device, defining therein an internal chamber that receives said socket, said insulating barrel and said locking device.

2. The floating fastener as claimed in claim 1, wherein said socket further comprises an accommodation open chamber disposed in a top side of said socket hole, and an elastic member mounted around said shank and said shoulder of said locking device with two opposite ends thereof respectively stopped against the said bottom wall of said head and an inside wall of said accommodation open chamber of said socket.

3. The floating fastener as claimed in claim 1, wherein said socket further comprises an annular top flange extended around a top side of socket hole, said annular top flange defining a bottom wall; said operating cap further comprises an annular stop flange defined in a bottom side of said internal chamber and stopped at said bottom wall of said annular top flange of said socket.

4. The floating fastener as claimed in claim 1, wherein a diameter of said barrel hole of said barrel is smaller than an outer diameter of said socket for enabling said socket to be press-fitted into said barrel hole.

5. The floating fastener as claimed in claim 1, wherein said insulating barrel further comprises an abutment structure extended around said bottom through hole, said abutment structure comprising an annular abutment flange disposed in flush with a bottom wall of said insulating barrel.

6. The floating fastener as claimed in claim 5, wherein said abutment structure further comprises a plurality of connection members respectively extended from an outer perimeter of said annular abutment flange and respectively terminating in an inwardly curved hook block.

7. The floating fastener as claimed in claim 5, wherein said abutment structure further comprises a plurality of hooks downwardly extended from said annular abutment flange.

8. The floating fastener as claimed in claim 1, wherein said head of said locking device exhibits a circular shape and comprises a driving tool receiving portion selectively made in the form of Phillips groove, hex groove, six-point star pattern groove or hex stem.

9. The floating fastener as claimed in claim 1, wherein said shank of said locking device comprises an outer thread spirally extended around a periphery of said shank thereof.

10. The floating fastener as claimed in claim 1, wherein said operating cap further comprises a mounting groove located in said internal chamber for the positioning of said head of said locking device.

11. The floating fastener as claimed in claim 1, wherein said operating cap further comprises a grip located at a periphery of said operating cap thereof.

12. The floating fastener as claimed in claim 11, wherein said grip of said operating cap comprises a plurality of anti-slip ribs spaced around a periphery of said grip of said operating cap.

13. The floating fastener as claimed in claim 11, wherein said grip of said operating cap comprises a plurality of finger blocks spaced around the periphery of said grip of said operating cap.
